(19) United States
(12) Patent Application Publication
(10) Pub. No.: US 2011/0072963 A1
(43) Pub. Date: Mar. 31, 2011

(54) Device for Sealing a Hydraulic Piston

(76) Inventor: Markus BUCK, Hulben (DE)

(21) Appl. No.: 12/896,367

(22) Filed: Oct. 1, 2010

Related U.S. Application Data
(63) Continuation-in-part of application No. PCT/EP09/02243, filed on Mar. 27, 2009.

(30) Foreign Application Priority Data
Apr. 3, 2008 (DE) 10 2008 017 035.6

(51) Int. Cl. F16J 9/12

(52) U.S. Cl. 92/240

(57) ABSTRACT

A device for sealing a hydraulic piston in a hydraulic cylinder includes a hydraulic piston defining a fluid side and an air side and having at least one sealing groove defining at least one sealing groove side wall and a sealing groove base. A lip seal is inserted into the sealing groove and comprises a sealing lip facing the fluid side and a seal back facing the air side. The hydraulic piston has means for improving sealing action of the lip seal comprising a shaping of the sealing groove on at least one of the at least one sealing groove side wall and/or the sealing groove base.

### CROSS-REFERENCE TO RELATED APPLICATION:

This is a continuation-in-part application, under 35 U.S.C. §120, of copending international application No. PCT/EP2009/002243, filed Mar. 27, 2009, which designated the United States and was not published in English; this application also claims the priority, under 35 U.S.C. §119, of German Patent Application No. 10 2008 017 035.6, filed Apr. 3, 2008; the prior applications are herewith incorporated by reference in their entirety.

### STATEMENT REGARDING FEDERALLY SPONSORED RESEARCH OR DEVELOPMENT

n/a

### FIELD OF THE INVENTION

The invention relates to a device for sealing a hydraulic piston in a hydraulic cylinder, the device comprising at least one sealing groove in the hydraulic piston and a lip seal inserted into the sealing groove. The lip seal comprises a sealing lip facing a fluid side and a seal back facing an air side.

### BACKGROUND OF THE INVENTION

Piston sealing devices are known and are used, for example, in hydraulic brake and clutch systems. Two sealing devices are generally disposed on a hydraulic piston of a hydraulic brake system: a primary seal is disposed on the pressure side of the piston and a secondary seal seals off the hydraulic system from air and/or the environment.

Due to friction of the lip seal against the cylinder wall, a tilting moment acts on the lip seal as the piston moves, particularly during the change between the forward and return movement. In so doing, the seal may lift off from sealing groove base in certain areas, forming a channel on the inside diameter of the seal and air can get into the cylinder chamber. In the case of a secondary seal for a hydraulic brake, the air can get into the hydraulic brake system, resulting in a migration of the pressure point of the brake, thereby adversely affecting the proportional delivery. However, the air may even lead to a failure of the brake system.

To reduce the risk of the seal lifting off from the groove base, German Published, Non-Prosecuted Patent Application DE 22 63 012 A, for example, discloses a division of the sealing groove into two portions of different axial length, which portions merge directly into one another. The longer portion has a cylindrical shape. In the shorter portion, the base circle diameter increases starting from the cylindrical portion. A lip seal, the inner free end of which rests against the groove base of the shorter portion and which is thereby more heavily compressed, is inserted into the sealing groove. The heavy compression of the free end causes greater friction between the seal and the inside wall of the hydraulic cylinder, however, so that operation (in particular the proportional delivery of a hydraulic brake, for example) may be impaired.

Thus, a need exists to overcome the problems with the prior art systems, designs, and processes as discussed above.

### SUMMARY OF THE INVENTION

The invention provides a device for sealing a hydraulic piston that overcomes the hereinafore-mentioned disadvantages of the heretofore-known devices and methods of this general type and that provide such features with a reduced risk of the seal tilting without, at the same time, substantially changing the friction between the seal and a hydraulic cylinder.

With the foregoing and other objects in view, there is provided, in accordance with the invention, a device for sealing a hydraulic piston in a hydraulic cylinder, comprising a hydraulic piston defining a fluid side and an air side and having at least one sealing groove defining at least one sealing groove side wall and a sealing groove base, a lip seal inserted into the sealing groove and comprising a sealing lip facing the fluid side and a seal back facing the air side, and the hydraulic piston having means for improving sealing action of the lip seal comprising a shaping of the sealing groove on at least one of the at least one sealing groove side wall and the sealing groove base.

With the objects of the invention in view, there is also provided, in a device for sealing a hydraulic piston in a hydraulic cylinder, the hydraulic piston defining a fluid side and an air side and having at least one sealing groove defining at least one sealing groove side wall and a sealing groove base, a lip seal inserted into the sealing groove and comprising a sealing lip facing the fluid side and a seal back facing the air side, an improvement comprising the hydraulic piston comprising a shaping of the sealing groove on at least one of the at least one sealing groove side wall and the sealing groove base for improving sealing action of the lip seal to the hydraulic cylinder.

With the objects of the invention in view, there is also provided a sealing-improved hydraulic piston for use in a hydraulic cylinder, comprising a piston body defining a fluid side and an air side and having at least one sealing groove defining at least one sealing groove side wall and a sealing groove base, a lip seal inserted into the sealing groove and comprising a sealing lip facing the fluid side and a seal back facing the air side, and the sealing groove having a shaping on at least one of the at least one sealing groove side wall and the sealing groove base for improving sealing action of the lip seal to the hydraulic cylinder.

The invention provides means for improving the sealing action of the lip seal at least by shaping the sealing groove on at least one sealing groove side wall and/or on the sealing groove base.

The means according to the invention for improving the sealing action are used primarily on the transmitting side of a hydraulic system, for example, in a manual control element or in a foot-operated transmitter of a hydraulic brake or clutch system. The invention can also be used on the receiving side of a hydraulic system, however, for example, on a hydraulically actuated clutch or on a brake master cylinder of a brake system.

The enhanced sealing action means that the hydraulic cylinder and the hydraulic piston can be of correspondingly smaller and more compact design. The hydraulic cylinder can thereby be located, for example, on a manual control element of radial as well as axial design.

In accordance with another feature of the invention, the at least one sealing groove has a groove diameter, the lip seal has a nominal diameter, and a difference in diameter between the groove diameter and the nominal diameter is approximately 0.1% to approximately 10% of the nominal diameter. In particular, a difference in diameter between the groove diameter and the nominal diameter is approximately 2% to approximately 3% of the nominal diameter.

In one embodiment for improving the sealing action, the selected diameter of the sealing groove is greater than the nominal diameter of the lip seal. This allows the seal to expand more and increases the pre-tensioning. At the same time the risk of tilting diminishes with the increasing difference in diameter and hence the increasing expansion of the seal. Here, the diameter of the sealing groove ranges, for example, from 0.1% to 10% greater than the nominal diameter of the seal. The difference in diameter in the case of a standard hydraulic piston used in motorcycles is approximately 2%-3% of the nominal diameter.

In accordance with a further feature of the invention, the lip seal is axially constrained in the sealing groove, for example, through corresponding dimensioning of the groove width or by a washer, which can be pushed in against the seal back, for example, after inserting the seal into the sealing groove. This serves to reduce the axial play of the seal, leaving no room for tilting.

In accordance with an added feature of the invention, the lip seal is adhesively bonded to a sealing groove side wall, for example, on the air side. The adhesive bond prevents the seal tilting and air getting into the hydraulic system. A permanently elastic, oil- or brake fluid-resistant adhesive may be used as adhesive.

In accordance with an additional feature of the invention, the sealing groove base is inclined and, for example, has a smaller depth on the fluid side than on the air side. This results in a greater tension on one side of the seal and hence better sealing. In addition the other side of the seal rests against a sealing groove side wall, so that the seal can no longer tilt. Here the angle between the sealing groove base and the longitudinal axis of the hydraulic piston is preferably between 0.1° and 6°, in particular approximately 2°.

In accordance with yet another feature of the invention, the at least one sealing groove side wall is inclined.

In accordance with yet a further feature of the invention, the at least one sealing groove side wall comprises a fluid side sealing groove side wall and the fluid side sealing groove side wall is inclined and the sealing groove width diminishes towards the groove base.

In accordance with yet an added feature of the invention, the sealing groove base is inclined.

In accordance with yet an additional feature of the invention, the hydraulic piston has a longitudinal axis and an angle between the sealing groove base and the longitudinal axis of the hydraulic piston is between approximately 0.1° and approximately 6°, in particular, approximately 2°.

In accordance with a concomitant feature of the invention, the sealing groove base has a fluid side and an air side and is inclined to have a smaller depth at the fluid side than at the air side.

Although the invention is illustrated and described herein as embodied in a device for sealing a hydraulic piston, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Further advantageous developments of the invention are set forth in the dependent claims, it being possible to use the measures described for improving the sealing action both individually and in any combination.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a fragmentary, cross-sectional view of a first exemplary embodiment of the invention with an enlarged nominal diameter of a sealing groove;

FIG. 2 is a fragmentary, cross-sectional view of a second exemplary embodiment of the invention having an axial washer;

FIG. 3 is a fragmentary, cross-sectional view of third exemplary embodiment of the invention with an adhesively bonded seal back;

FIG. 4 is a fragmentary, cross-sectional view of a fourth exemplary embodiment of the invention with an inclined sealing groove side wall;

FIG. 5 is a fragmentary, cross-sectional view of a fifth exemplary embodiment of the invention with an inclined sealing groove base;

FIG. 6 is a fragmentary, cross-sectional view of a brake control element having a hydraulic piston according to the exemplary embodiment of FIG. 5; and

FIG. 7 is a fragmentary, longitudinally cross-sectional view of a hydraulic piston of FIG. 6.

### DETAILED DESCRIPTION OF THE INVENTION

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

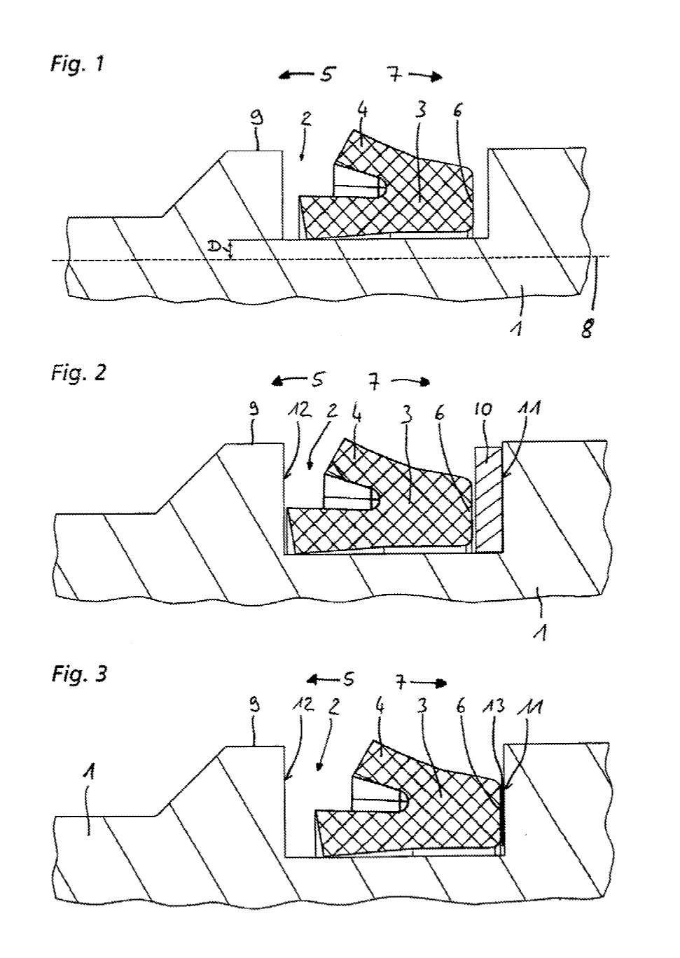

Described now are exemplary embodiments of the present invention. Referring now to the figures of the drawings in detail and first, particularly to FIG. 1, there is shown a first exemplary embodiment of a hydraulic brake piston 1 in the area of a secondary sealing device comprising a sealing groove 2 and a lip seal 3. The lip seal 3 inserted in the sealing groove 2 and comprises a sealing lip 4 and seal back 6. The sealing lip 4 in this case points towards the fluid or oil side 5 of the piston 1 and the seal back 6 faces the air side 7 of the piston 1.

The sealing groove 2 has a larger outside diameter than the nominal diameter 8 of the lip seal 3, indicated by a dashed line. In the example depicted, the difference D is approximately 0.15 mm for a nominal diameter of the piston of approximately 5.5 mm, which corresponds to approximately 2.5% of this nominal diameter. This increases the extent to which the sealing lip 4 projects beyond the groove upper edge 9 and, thereby, the compression of the lip seal 3 in the fitted state. Any other difference in diameter D ranging from 0.1% to 10% or more of the nominal diameter, for example, is feasible according to the desired additional compression.

In the embodiment of the invention shown in FIG. 2, a washer 10, which reduces the axial play of the lip seal 3, is inserted on the air side 7 between the seal back 6 of the lip seal 3 and the sealing groove side wall 11. This means that on both sides of the lip seal 3 only a slight gap remains between the seal 3 and the respective sealing groove side wall 11, 12, so that a tilting of the seal 3 is no longer possible. In an exemplary embodiment, the washer 10 is made from elastic material, so that it can be pushed into the sealing groove 2 after inserting the seal 3.

FIG. 3 shows a third exemplary embodiment of the invention, in which the seal back 6 is adhesively bonded to the air-side sealing groove side wall 11. In this exemplary embodiment, the adhesive 13 is permanently elastic and oil or brake fluid-resistant.

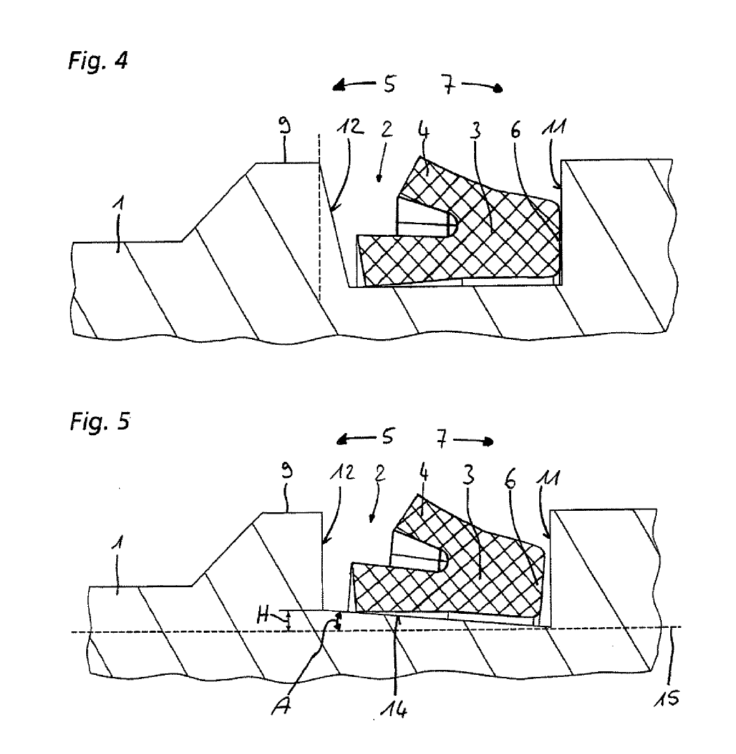

In the exemplary embodiment shown in FIG. 4, the sealing groove side wall 12 situated on the fluid side 5 is inclined, the groove width diminishing towards the groove base 14. The lip seal 3, thereby, rests with the seal back 6 substantially against the air-side sealing groove side wall 11, thereby reducing the risk of tilting.

The exemplary embodiment represented in FIG. 5 has an inclined sealing groove base 14, which slopes linearly from the fluid-side sealing groove side wall 12 towards the air-side sealing groove side wall 11, that is to say over the entire width of the sealing groove 2, so that the groove depth is less on the fluid side 5 than on the air side 7. The lip seal 3, in this case, lies at an inclined angle in the sealing groove 2. This means that the seal 3 is more heavily compressed in the area of the sealing lip 4, thereby improving contact pressure of the sealing lip 4 against a surrounding cylinder wall (not shown). Alternatively, the sealing groove base 14 could also comprise one or more steps, against the edges of which the lip seal 3 could rest at an inclined angle.

Here, therefore, it is only the fluid-side seal part, which contributes primarily to the sealing, that is positioned radially further outwards, rather than the entire seal. This means that the overall contact pressure of the outer sealing lip 4 against the cylinder is also comparatively low and largely corresponds to the contact pressure of seals of conventional design and configurations.

Due to the inclination of the groove base 14, the seal 3 is already situated in a “tilted position”, so that virtually no further tilting can occur. In addition, a longitudinal shifting of the seal is virtually excluded due to the friction occurring on the inclined groove base. When a tilting moment acts on the outer sealing lip 4, the already inclined position of the seal 3 prevents any further tilting, so that the inner, air-side sealing face also cannot rise up.

In addition, the seal back 6 on the air side may rest, in its entirety or in certain areas, against the sealing groove side wall 11, so that the risk of the seal 3 tilting is further reduced.

In this exemplary embodiment, the angle A between the sealing groove base 14 and the longitudinal axis 15 of the hydraulic cylinder is between 0.1° and 6°.

In an exemplary embodiment, the difference in height H along the sealing groove base 14 is 0.15 mm for a sealing groove length of approximately 4.5 mm. Here, the angle A is approximately 2°. In other exemplary embodiments, the sealing groove base 14 is between approximately 0.05 mm and approximately 0.3 mm or between approximately 0.1 mm and approximately 0.2 mm. In additional exemplary embodiments, the sealing groove length is between approximately 1 mm and approximately 10 mm, between approximately 2 mm and approximately 8 mm, between approximately 3 mm and approximately 6 mm, or between approximately 4 mm and approximately 5 mm. In still other exemplary embodiments, the angle A is between approximately 0.1° and approximately 6°, between approximately 0.5° and approximately 5°, between approximately 1° and approximately 4°, or between approximately 1.5° and approximately 3°.

The embodiment shown in FIG. 5 also has the advantage of being easier to assemble and manufacture.

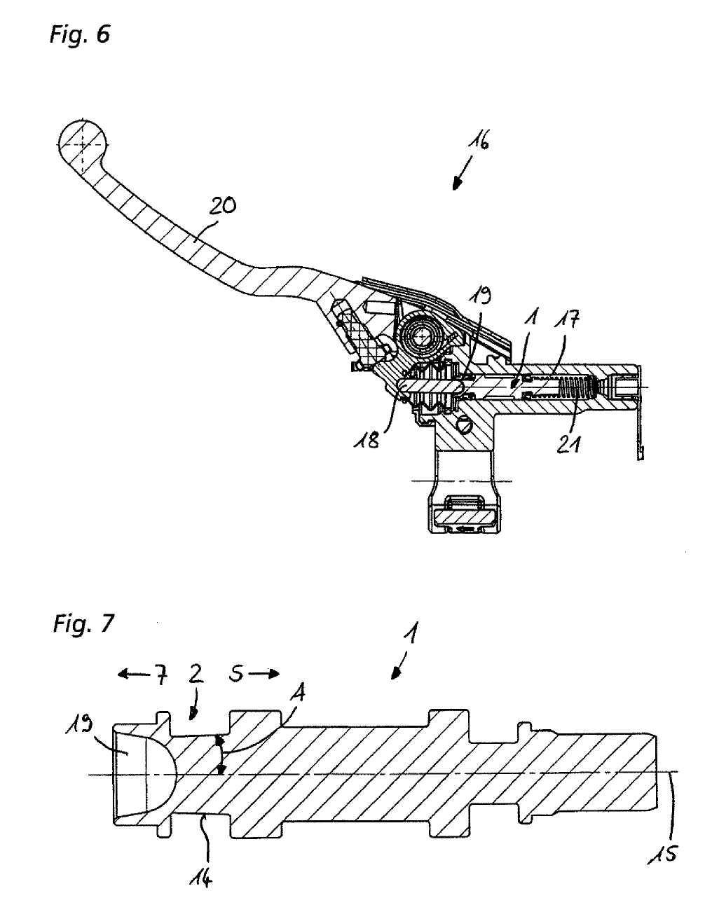

FIG. 6 shows a manual control element 16 of a hydraulic brake system of a motorcycle by way of example. The manual control element 16 comprises an hydraulic cylinder 17, in which a brake piston 1 is moveably supported. The brake piston 1 is connected through a plunger rod 18, which engages in a spherical indentation 19 on the air side 5 of the brake piston 1, to the hand-lever 20 of the control element 16. Accordingly, a compressive movement of the hand lever 20 produces a movement of the brake piston 1. The brake piston 1 and the hand lever 20 are returned solely by a return spring 21 on the oil side 5 of the hydraulic cylinder 17. It is noted that the manual control element 16 may also be of any other design configuration, however, so that the invention is in no way limited to this example.

The brake piston 1 comprises a seal improvement device or means for improving the sealing action according to FIG. 5. As shown in more detail in FIG. 7, the sealing groove 2 has a sealing groove base 14 running at an inclined angle to the longitudinal axis 15 of the piston 1, the groove depth being less on the oil side 5 than on the air side 7. In the example shown, the angle A between the groove base 14 and the longitudinal axis 15 is approximately 2°.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A device for sealing a hydraulic piston in a hydraulic cylinder, comprising:
a hydraulic piston:
defining a fluid side and an air side; and
having at least one sealing groove defining at least one sealing groove side wall and a sealing groove base;
a lip seal inserted into the sealing groove and comprising a sealing lip facing the fluid side and a seal back facing the air side; and
the hydraulic piston having means for improving sealing action of the lip seal comprising a shaping of the sealing groove on at least one of:
the at least one sealing groove side wall; and
the sealing groove base.

2. The device according to claim 1, wherein:
the at least one sealing groove has a groove diameter;
the lip seal has a nominal diameter; and
a difference in diameter between the groove diameter and the nominal diameter is approximately 0.1% to approximately 10% of the nominal diameter.

3. The device according to claim 1, wherein:
the at least one sealing groove has a groove diameter;
the lip seal has a nominal diameter; and
a difference in diameter between the groove diameter and the nominal diameter is approximately 2% to approximately 3% of the nominal diameter.

4. The device according to claim 1, wherein the lip seal is axially constrained in the at least one sealing groove.

5. The device according to claim 4, wherein the lip seal is axially constrained in the at least one sealing groove by at least one of:
a corresponding dimensioning of a width of the at least one sealing groove; and
a washer.

6. The device according to claim 1, wherein the lip seal is adhesively bonded to the at least one sealing groove side wall.

7. The device according to claim 1, wherein:
the at least one sealing groove side wall comprises an air side sealing groove side wall; and
the lip seal is adhesively bonded to the air side sealing groove side wall.

8. The device according to claim 1, wherein the at least one sealing groove side wall is inclined.

9. The device according to claim 1, wherein:
the at least one sealing groove side wall comprises a fluid side sealing groove side wall; and
the fluid side sealing groove side wall is inclined and a width of the at least one sealing groove diminishes towards the sealing groove base.

10. The device according to claim 1, wherein the sealing groove base is inclined.

11. The device according to claim 10, wherein:
the hydraulic piston has a longitudinal axis; and
an angle between the sealing groove base and the longitudinal axis of the hydraulic piston is between approximately 0.1° and approximately 6°.

12. The device according to claim 11, wherein the angle between the sealing groove base and the longitudinal axis of the hydraulic piston is approximately 2°.

13. The device according to claim 1, wherein the sealing groove base:
has a fluid side and an air side; and
is inclined to have a smaller depth at the fluid side than at the air side.

14. The device according to claim 13, wherein:
the hydraulic piston has a longitudinal axis; and
an angle between the sealing groove base and the longitudinal axis of the hydraulic piston is between approximately 0.1° and approximately 6°.

15. The device according to claim 14, wherein the angle between the sealing groove base and the longitudinal axis of the hydraulic piston is approximately 2°.

16. In a device for sealing a hydraulic piston in a hydraulic cylinder, the hydraulic piston defining a fluid side and an air side and having at least one sealing groove defining at least one sealing groove side wall and a sealing groove base, a lip seal inserted into the sealing groove and comprising a sealing lip facing the fluid side and a seal back facing the air side, the improvement comprising:
the hydraulic piston comprising a shaping of the sealing groove on at least one of:
the at least one sealing groove side wall; and
the sealing groove base,
for improving sealing action of the lip seal to the hydraulic cylinder.

17. A sealing-improved hydraulic piston for use in a hydraulic cylinder, comprising:
a piston body defining a fluid side and an air side and having at least one sealing groove defining at least one sealing groove side wall and a sealing groove base;
a lip seal inserted into the sealing groove and comprising a sealing lip facing the fluid side and a seal back facing the air side; and
the sealing groove having a shaping on at least one of:
the at least one sealing groove side wall; and
the sealing groove base,
for improving sealing action of the lip seal to the hydraulic cylinder.

18. The device according to claim 17, wherein:
the at least one sealing groove has a groove diameter;
the lip seal has a nominal diameter; and
a difference in diameter between the groove diameter and the nominal diameter is approximately 0.1% to approximately 10% of the nominal diameter.

19. The device according to claim 17, wherein the lip seal is axially constrained in the at least one sealing groove by at least one of:
a corresponding dimensioning of a width of the at least one sealing groove; and
a washer.

20. The device according to claim 17, wherein at least one of the sealing groove base and the at least one sealing groove side wall is inclined.
